(19) United States
(12) Patent Application Publication
(10) Pub. No.: US 2006/0278482 A1
(43) Pub. Date: Dec. 14, 2006

(54) Method of securing a shim to a brake pad assembly backing plate and brake pad assembly obtained thereby

(76) Inventors: Stewart Kahan, Dollard-des-Ormeaux (CA); Patrick Savage, Cornwall (CA); Kenneth Schouten, Hudson (CA)

Correspondence Address: LESPERANCE & MARTINEAU, 1440 WEST, STE-CATHERINE ROOM 700, MONTREAL, QC, H3G1R8, CA

(21) Appl. No.: 11/150,170

(22) Filed: Jun. 13, 2005

(51) Int. Cl. F16D 65/38

(52) U.S. Cl. 188/250 G; 188/250 R

(57) ABSTRACT

The method of manufacturing a brake pad assembly for use in a disc brake assembly, comprises the following steps: providing a backing plate defining distinct shim and friction pad surfaces, the backing plate destined to carry a friction pad on the friction pad surface and comprising at least one recess on the backing plate shim surface, the recess defining an inner peripheral wall having a top rim; providing a shim defining an abutment surface; applying the shim abutment surface against the backing plate shim surface; and forcing the shim to deform locally into the recess and against the recess inner peripheral wall so that a shim lip projecting transversely away from the shim abutment surface will be forced to deform towards the recess inner peripheral wall to become pressure-fitted within the recess thereby securing the shim to the backing plate.

### FIELD OF THE INVENTION

The present invention relates to brake pad assemblies for vehicle disc brake assemblies, and more particularly to a method of securing a shim to a brake pad assembly backing plate.

### BACKGROUND OF THE INVENTION

In a vehicle disc brake assembly, a disc rotor rotates with the axle of the wheel to be braked. A generally U-shaped caliper engages the disc, with the caliper carrying a pair of brake pad assemblies positioned on opposite sides of the disc. Each brake pad assembly comprises a steel backing plate equipped with a corresponding molded friction pad fixedly attached to the backing plate in facing register with the disc. As the backing plates move inwardly under the force supplied by an actuator piston carried by the caliper, the inner surfaces of the friction pads are engaged in frictional braking contact with the disc. Vibration of the brake members during braking actuation can produce an undesirable high pitched brake squeal noise.

To reduce or eliminate the undesired brake squeal noise, sound dampening members, commonly referred to as shims, have been used by both original equipment manufacturers and by brake repair shops. These noise dampening shims are substantially flat metallic plates positioned between the actuated piston and the back surface of the related brake pad assembly steel backing plate and also between the caliper and the back surface of the related brake pad assembly steel backing plate.

Unfortunately, this frictional contact can cause a torque or twisting force on the shim by the related piston or caliper producing a shearing force in the adhesive of the shim if adhesive is employed to attach the shim to the backing plate. Under the extreme conditions of heat and vibration that the brake pad assemblies are subjected to, the adhesive by itself is not sufficient to prevent accidental dislodging of the shim from the backing plate during braking. Excessive vibration can cause any mechanical fastener (such as a staple or rivet) to detach from the assembly and become accidentally lodged between the caliper piston and the brake pad, potentially affecting performance of the braking system.

It is known to provide brake pad assemblies that are designed to further reduce shifting of the shim during braking, that include shims having one or more extruded holes that align with corresponding preformed aligned recesses in the back surface of the backing plate. Fasteners such as rivets are driven through the shim holes and the backing plate recesses, to integrally anchor the shim to the backing plate. However, not only are the rivets subject to accidental dislodgement during use, as indicated hereinabove, but also the production of the brake pad assembly is complicated by the installation of these rivets. However, this construction yields a very desirable reduction on the shearing motion of the shim, in addition to the shim providing its known noise dampening effect.

According to this latter brake pad assembly embodiment, the brake pad assembly backing plates are prepared prior to the shims being installed thereon. Firstly, the backing plates are washed clean of any lubricants or rust preventatives that may have been employed during the stamping process. The cleaned metal backing plates are then subjected to an abrasive grit blasting operation in which small metal pellets are blasted against the backing plate, to increase the surface roughness thereof, for example in range of 300 to 500 micro inches. This is done for the purpose of

### SUMMARY OF THE INVENTION

The present invention relates to a method in a brake pad assembly for use in a disc brake assembly, of securing a shim to a backing plate, with said backing plate defining distinct shim and friction pad surfaces and destined to carry a friction pad on said friction pad surface, and with said shim defining an abutment surface, said method comprising the following steps:

forming at least one recess in said backing plate shim surface, said recess defining an inner peripheral wall having a top rim;

applying said shim abutment surface against said backing plate shim surface; and

forcing said shim to deform locally into said recess and against said recess inner peripheral wall so that a shim lip projecting transversely away from said shim abutment surface will be forced to deform towards said recess inner peripheral wall to become pressure-fitted within said recess thereby securing said shim to said backing plate.

In one embodiment, the method also comprises the following step before the step of applying said shim abutment surface against said backing plate shim surface:

forming at least one embossment on said shim, said embossment defining said shim lip about an embossment hole and defining an embossment bottom wall within said embossment hole integrally formed with said lip;

wherein the step of applying said shim abutment surface against said backing plate shim surface is accomplished so that said shim embossment registers with said backing plate recess and so that said shim lip extends into said backing plate recess.

In an alternate embodiment, the method instead comprises the following steps before the step of applying said shim abutment surface against said backing plate shim surface:

forming at least one hole through said shim; and

forming said lip on said shim about said hole;

wherein the step of applying said shim abutment surface against said backing plate shim surface is accomplished so that said shim hole registers with said backing plate recess and so that said shim lip extends into said backing plate recess.

In one embodiment, the method further comprises the following step before said shim abutment surface is applied against said backing plate shim surface:

forming an annular shoulder on said backing plate at said inner peripheral wall rim that projects within said recess, wherein upon said shim lip being deformed against said recess inner peripheral wall, said shim lip will partly engage an area underneath said annular shoulder within said recess to be axially retained by said annular shoulder.

In one embodiment, said annular shoulder is formed in said recess by said backing plate formed with said recess being subjected to an abrasive grit blasting operation.

In one embodiment, said hole is formed on said shim by a punching operation accomplished before said shim abutment surface is applied against said backing plate shim surface, said lip being formed concurrently with said hole due to the material of said shim plastically deforming during said punching operation and bending outwardly transversely of said shim abutment surface.

In one embodiment, said shim lip is forced to deform against said recess inner peripheral wall by means of a coining punch that is driven into said hole and said recess when said lip engages said recess, with the diameter of said coining punch being larger than the diameter of said shim lip.

In one embodiment, said coining punch is power-driven into said hole and said recess against the bias of a biasing member biasing said punch away from said hole and said recess, and said punch is retrieved from said hole and said recess by the action of said biasing member.

In one embodiment, the method further comprises the following step before said shim abutment surface is applied against said backing plate shim surface:

forming an annular shoulder on said backing plate at said inner peripheral wall rim that projects within said recess, wherein upon said shim lip being deformed against said recess inner peripheral wall, said shim lip will partly engage an area underneath said annular shoulder within said recess to be axially retained by said annular shoulder;

wherein upon said coining punch being driven into said hole and said recess, not only will said shim lip deform against said recess inner peripheral wall, but also said shim lip will force said annular shoulder to elastically yieldingly stretch to allow the insertion of said coining punch in said hole and said recess, with said annular shoulder springing back towards its initial position under its intrinsic resiliency upon said coining punch being retrieved from said hole and said recess, said annular shoulder thus gripping said shim lip.

In one embodiment, there are three recesses formed in said backing plate shim surface and three holes bordered by corresponding lips formed in said shim.

The present invention also relates to a method of manufacturing a brake pad assembly for use in a disc brake assembly, comprising the following steps:

providing a backing plate defining distinct shim and friction pad surfaces, said backing plate destined to carry a friction pad on said friction pad surface and comprising at least one recess on said backing plate shim surface, said recess defining an inner peripheral wall having a top rim;

providing a shim defining an abutment surface;

applying said shim abutment surface against said backing plate shim surface; and

forcing said shim to deform locally into said recess and against said recess inner peripheral wall so that a shim lip projecting transversely away from said shim abutment surface will be forced to deform towards said recess inner peripheral wall to become pressure-fitted within said recess thereby securing said shim to said backing plate.

In one embodiment, in the step of providing said shim, said shim comprises at least one embossment comprising said lip about an embossment hole and an embossment bottom wall integrally formed with said lip within said embossment hole, with the step of applying said shim abutment surface against said backing plate shim surface being accomplished so that said shim embossment registers with said backing plate recess and so that said shim lip extends into said backing plate recess.

In an alternate embodiment, in the step of providing said shim, said shim comprises at least one hole and is provided with said lip about said hole, with the step of applying said shim abutment surface against said backing plate shim surface being accomplished so that said shim hole registers with said backing plate recess and so that said shim lip extends into said backing plate recess.

In one embodiment, said backing plate comprises an annular shoulder at said inner peripheral wall rim projecting within said recess, wherein upon said shim lip being deformed against said recess inner peripheral wall, said shim lip will partly engage an area underneath said annular shoulder within said recess to be axially retained by said annular shoulder.

In one embodiment, said shim lip is made with material of said shim that plastically deformed when said hole was formed and bending outwardly transversely of said shim abutment surface.

In one embodiment, said shim lip is forced to deform against said recess inner wall by means of a punch that is driven into said hole and said recess when said lip engages said recess, with the diameter of said punch being larger than the diameter of said shim lip.

In one embodiment, said punch is power-driven into said hole and said recess against the bias of a biasing member biasing said punch away from said hole and said recess, and said punch is retrieved from said hole and said recess by the action of said biasing member.

In one embodiment, in the step of providing said backing plate, said backing plate comprises an annular shoulder at said inner peripheral wall rim that projects within said recess, wherein upon said shim lip being deformed against said recess inner peripheral wall, said shim lip will partly engage an area underneath said annular shoulder within said recess to be axially retained by said annular shoulder;

and wherein upon said coining punch being driven into said hole and said recess, not only will said shim lip deform against said recess inner peripheral wall, but also said shim lip will force said annular shoulder to elastically yieldingly stretch to allow the insertion of said coining punch in said hole and said recess, with said annular shoulder springing back towards its initial position under its intrinsic resiliency upon said coining punch being retrieved from said hole and said recess, said annular shoulder thus gripping said shim lip.

The present invention further relates to a brake pad assembly for use in a disc brake assembly, comprising:

a backing plate defining distinct shim and friction pad surfaces;

a friction pad fixedly attached to said backing plate on said friction pad surface;

a recess made in said backing plate on said shim surface, said recess defining an inner bottom wall and an inner peripheral wall having a top rim;

a shim defining an abutment surface resting against said backing plate shim surface;

a hole made in said shim and registering with said recess;

a lip integrally carried by said shim and projecting within said recess transversely away from said shim abutment surface about said hole, said lip being formed peripherally about a same axis as said hole and engaging said recess inner peripheral wall in pressure-fitted fashion.

In one embodiment, said backing plate defines an annular shoulder projecting inwardly of said recess at said recess inner peripheral wall top rim, with said lip engaging an area within said recess underneath said shoulder whereby said shim is retained by said shoulder.

In one embodiment, said shim defines an embossment defining said hole, with said shim further defining an embossment bottom wall integrally formed with said lip within said embossment hole.

### DESCRIPTION OF THE DRAWINGS

In the annexed drawings:

FIG. 1 is a perspective view of a brake pad assembly according to the present invention;

FIG. 2 is an exploded perspective view of the brake pad of FIG. 1;

FIG. 3 is an enlarged diametrical cross-sectional view of a recess of the backing plate of the brake pad of FIG. 1, with the recess being shown in its initial configuration before the abrasive grit blasting operation;

FIG. 4 is similar to FIG. 3, but showing the recess in its final configuration after the abrasive grit blasting operation, with the inwardly projecting shoulder formed at the top rim of the recess being emphasized to facilitate the visual appreciation of same; and

FIGS. 5, 6 and 7 sequentially show a punch being inserted into and then retrieved from the mutually registering shim hole and backing plate recess of the brake pad assembly to secure the shim to the backing plate.

### DETAILED DESCRIPTION OF THE EMBODIMENTS

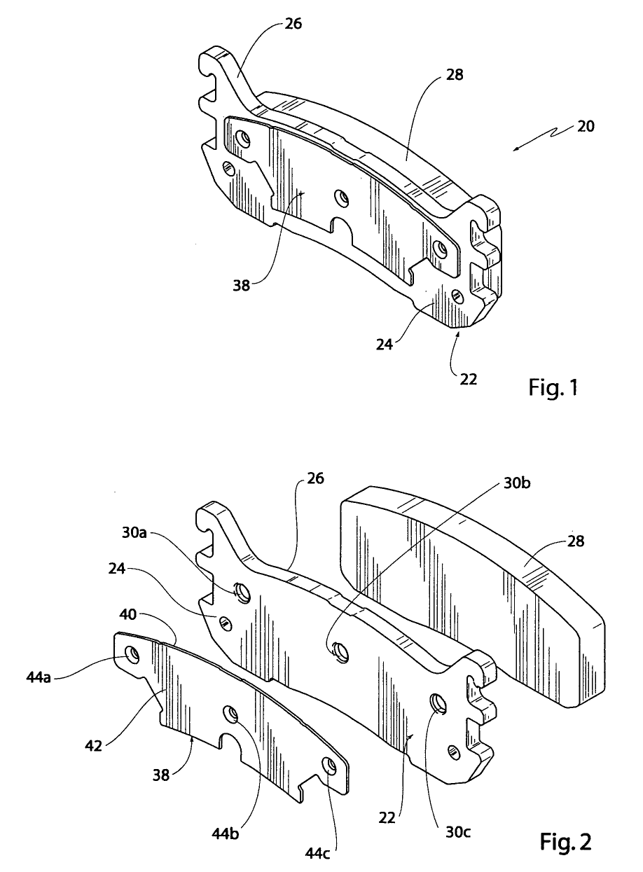

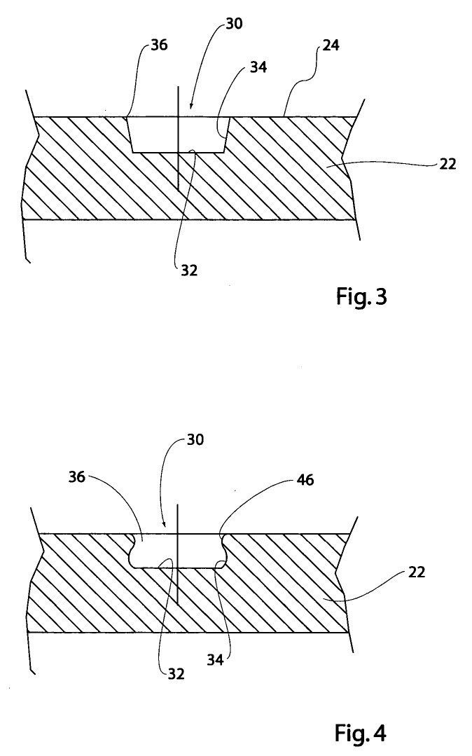

FIGS. 1 and 2 show a brake pad assembly 20 for use in a disc brake assembly (not shown) for motor vehicles. Brake pad assembly 20 comprises a substantially flat backing plate 22 defining a shim surface 24 and a friction pad surface 26 opposite shim surface 24. A friction pad 28 is fixedly attached to backing plate 22 on friction pad surface 26.

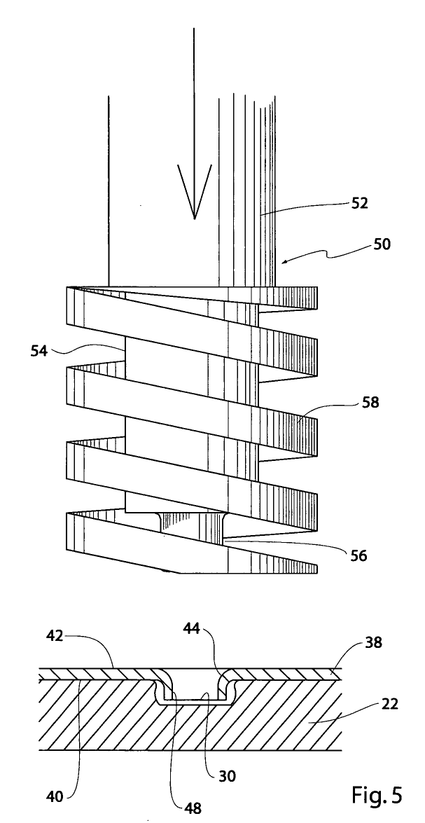

At least one recess, and for example three recesses 30a, 30b, 30c (generally referred to as recesses 30 in the present specification), are made in backing plate 22 on its shim surface 24. As shown in FIG. 3, each recess 30 defines an inner bottom wall 32 and an inner peripheral wall 34 having a top rim 36.

A noise dampening shim 38 is installed on backing plate 22 in a manner described hereinafter. Shim 38 defines a substantially flat abutment surface 40 and an opposite free surface 42, with abutment surface 40 resting against backing plate shim surface 24. Free surface 42 will be located between backing plate 22 and either the caliper (not shown) or the caliper piston (not shown) once brake pad assembly 20 is operatively installed in a disc brake assembly (not shown). Shim 38 comprises at least one hole, and for example three holes 44a, 44b, 44c (generally referred to as holes 44 in the present specification).

According to the present invention, there is provided a method in the brake pad assembly 20 of securing shim 38 to backing plate 22. First, backing plate 22, which can be made of any suitable material such as SAEI010-1018 hot rolled or cold rolled steel (optionally covered by a known protective coating), is stamped according to known stamping methods and embossed to form recesses 30 on its shim surface 24. Recesses 30 can be made with any suitable depth or diameter that allow the present invention to be carried out—as will be obvious for someone skilled in the art of the present invention—for example with a depth of 0.055 inch to 0.065 inch and a diameter of 0.195 inch to 0.205 inch and with a 20° draft (see FIG. 3). Backing plate 22 is then washed clean of any lubricants or rust preventatives that may have been employed in the stamping process. The clean metal backing plates are thereafter subjected to an abrasive grit blasting operation in which small metal pellets are blasted against the backing plate to increase the surface roughness to a suitable degree, for example in the range of 300 to 500 micro inches (average value). The purpose of this operation in prior art methods was to provide optimum surface contact area for an adhesion promoter substance of known composition that is added to the backing plate 22 prior to compression molding the friction pad 28 to the backing plate 22.

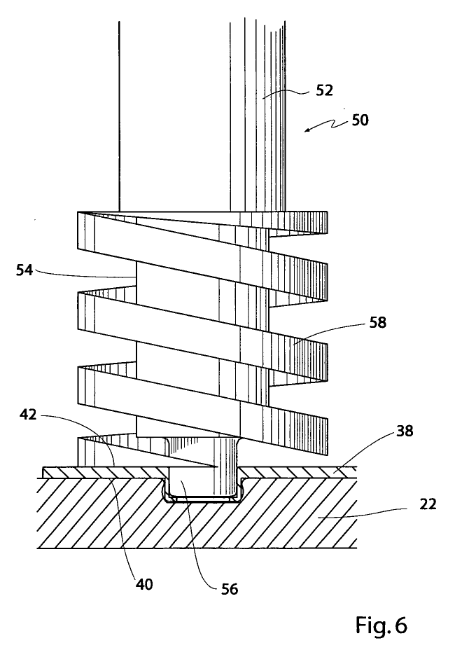

However, unexpected and advantageous results have been found when a backing plate 22 is subjected to the abrasive grit blasting operation where recesses 30 are pre-made therein. Indeed, in such a case the configuration of the inner cavity of recesses 30 is changed by the high-velocity pellet flow therein, whereby instead of keeping the generally inwardly convex shape provided by the inwardly convergent peripheral wall 34 configuration shown in FIG. 3, the final shape of recesses 30 is as shown in FIG. 4, i.e. recess 30 then comprises a slightly inwardly concave shape and defines an annular shoulder 46 that projects radially inwardly at the recess inner peripheral wall top rim 36. FIG. 3 and FIGS. 4-7 respectively show backing plate 22 before and after the abrasive grit blasting operation, with the inwardly concave shape of recess 30 and with the inward bulge of shoulder 46 being exaggerated in FIGS. 4-7 to more clearly show the effect of the grit blasting operation.

Shim 38 can be made of any suitable material, preferably a ferrous or non-ferrous metal. Each hole 44 is pierced through shim 38 with a suitable piercing punch (not shown), with the piercing punch not only forming holes 44 but in the process plastically deforming the metallic shim to form a lip 48 carried by shim 38 and projecting transversely away from shim abutment surface 40 about hole 44. Lip 48 is thus formed peripherally about a same axis as its corresponding hole 44.

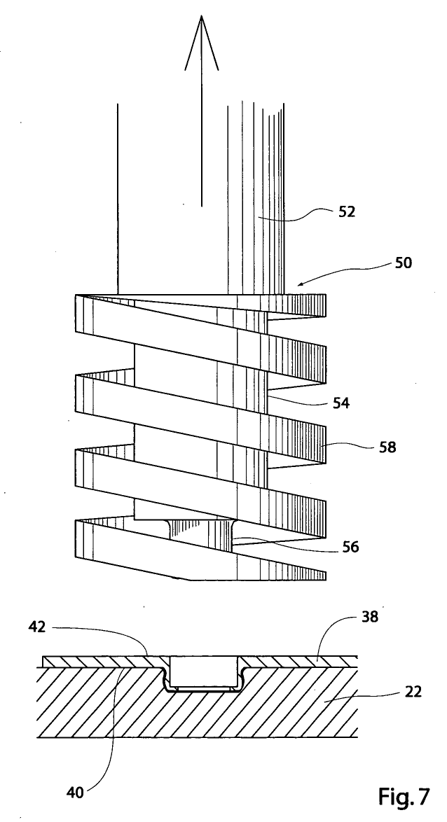

To secure shim 38 to the prepared backing plate 22, shim 38 is applied against backing plate 22, and more particularly the shim abutment surface 40 is applied against the backing plate shim surface 24 so that the shim hole 44 registers with the backing plate recesses 30 and so that the shim lips 48 project into the backing plate recesses 30, as shown in FIG. 5.

Then, a coining punch 50 is used to secure shim 38 to backing plate 22. Coining punch 50 comprises a sleeve 52 in which a piston 54 is axially movable. Piston 54 has a striking head 56 of a desired dimension, which will be larger than the inner diameter of lip 48 of shim hole 44. Thus, upon coining punch head 56 being inserted into hole 44 as shown in FIG. 6, the latter will be widened and shim lip 48 will be forced to deform against the recess inner peripheral wall 34 so that the shim lip 48 will become pressure-fitted within recess 30 thereby securing shim 38 to backing plate 22.

More particularly, according to the embodiment shown in the annexed drawings, lip 48 will deform and partly engage the area underneath shoulder 46 of the recess peripheral wall rim 36. Although the simple pressure-fit of lip 48 against a straight recess peripheral wall 34 might be sufficient to retain shim 38 to backing plate 22, this engagement of lip 48 under shoulder 46 will significantly help prevent accidental disengagement of shim 38 from backing plate 22.

After coining punch head 56 is power-driven into hole 44 and recess 30, it is retrieved therefrom by the action of a biasing member in the form of a spring 58 that abuts against the free surface 42 of shim 38 (as suggested in FIG. 6) and that biases punch head 56 away from hole 44 and recess 30 when punch head 56 is inserted therein. Thus, punch head 56 may be retrieved from hole 44 and recess 30 as suggested in FIG. 7.

To promote a positive pressure-fit of lip 48 against the hole peripheral wall 34, not only is the diameter of coining punch head 56 larger than that of lip 48 and hole 44, but also the diameter of punch head 56 is such that even the backing plate shoulder 46 will slightly yieldingly move outwardly under the bias of lip 48 being stretched by punch head 56, upon punch head 56 being inserted into recess 30. This outward diametrical increase of shoulder 46 is temporary however, i.e. this is not a plastic deformation but rather an elastic deformation. Indeed, upon punch head 56 being retrieved from recess 30, shoulder 46 will inwardly spring back towards its initial position under its intrinsic resiliency, thus firmly gripping lip 48 to increase the pressure-fit of lip 48 in recess 30 and consequently to further secure shim 38 to backing plate 22.

It is understood that if there are more than one hole 44 and recess 30 in which a coining punch is to be driven, one punch per hole 44 and recess 30 may be used to allow a single punching operation in which all punches are simultaneously driven into corresponding holes 44 and recesses 30 to accelerate the entire process.

Also, it is noted that although the method of manufacturing the brake pad assembly described hereinabove includes the step of piercing a hole through shim 38 before shim 38 is applied against backing plate 22, alternate ways to carry out the invention are envisioned wherein the shim is simply embossed instead of being pierced, in which case the embossment will also define an inner lip similar to the one shown in the annexed drawings in addition to an embossment bottom wall integrally formed with the lip; or wherein the shim is neither embossed nor pierced prior to being applied against the backing plate shim surface, with the shim instead being forced upon the coining punch being driven into the backing plate recess to deform locally into the backing plate recess and against the recess inner peripheral wall so that a shim lip will concurrently become pressure-fitted within the recess peripheral wall thereby securing said shim to said backing plate. Thus, it can be seen that the shim lip can be formed either when a shim hole or embossment is being formed prior to the shim being applied against the backing plate, or alternately when the coining punch is used to secure the shim to the backing plate after the shim is applied to the backing plate. In all embodiments, the shim is deformed locally within the recess when the coining punch is driven into the shim hole, and a shim lip is formed at one point or another to become pressure-fitted within a corresponding backing plate recess.

It is further noted that a single pair of mutually registering recess 30 and hole 44 could be sufficient to retain shim 38 to backing plate 22.

Recesses 30 may be formed according to any suitable process, including milling, punching, stamping, drilling, or any other manner in which recesses 30 may be formed. Likewise, hole 44 may be formed according to any suitable process. It is understood however that by punching a hole 44 through shim 38, a lip 48 is concurrently formed, which is advantageous since it does not require an additional step in the manufacturing process of shim 38. However, other means of forming a lip could also be envisioned, including adding a lip after hole 44 has been pierced.

It is noted that the step of applying the shim abutment surface against the backing plate shim surface will be accomplished so that the shim holes register with the corresponding backing plate recesses and so that the shim lips extend into the backing plate recesses only if the holes are preformed in the shim. However, in the case where no holes or embossments are preformed in the shim, applying the shim against the backing plate is accomplished by simply resting the shim against the backing plate; in such a case, other alignment means could be used if necessary to properly position the shim.

In view of the above comments, the method of the present invention can be defined as follows:

forming at least one recess in the backing plate shim surface, the recess defining an inner peripheral wall having a top rim;

applying the shim abutment surface against the backing plate shim surface; and

forcing the shim to deform locally into the recess and against the recess inner peripheral wall so that a shim lip will become pressure-fitted within the recess thereby securing the shim to the backing plate.

Also, the method of the present invention can be defined as follows:

providing a backing plate defining distinct shim and friction pad surfaces, the backing plate destined to carry a friction pad on the friction pad surface and comprising at least one recess on the backing plate shim surface, the recess defining an inner peripheral wall having a top rim;

providing a shim defining an abutment surface;

applying the shim abutment surface against the backing plate shim surface; and

forcing the shim to deform locally into the recess and against the recess inner peripheral wall so that a shim lip will become pressure-fitted within the recess against the recess inner peripheral wall, whereby the shim becomes secured to the backing plate.

Any further modification to the above-described embodiments which would be obvious to a person skilled in the art of the present invention, is considered to be encompassed within the scope of the appended claims.

1. A method in a brake pad assembly for use in a disc brake assembly, of securing a shim to a backing plate, with said backing plate defining distinct shim and friction pad surfaces and destined to carry a friction pad on said friction pad surface, and with said shim defining an abutment surface, said method comprising the following steps:
forming at least one recess in said backing plate shim surface, said recess defining an inner peripheral wall having a top rim;
applying said shim abutment surface against said backing plate shim surface; and
forcing said shim to deform locally into said recess and against said recess inner peripheral wall so that a shim lip projecting transversely away from said shim abutment surface will be forced to deform towards said recess inner peripheral wall to become pressure-fitted within said recess thereby securing said shim to said backing plate.

2. A method as defined in claim 1, comprising the following step before the step of applying said shim abutment surface against said backing plate shim surface:
forming at least one embossment on said shim, said embossment defining said shim lip about an embossment hole and defining an embossment bottom wall within said embossment hole integrally formed with said lip;
wherein the step of applying said shim abutment surface against said backing plate shim surface is accomplished so that said shim embossment registers with said backing plate recess and so that said shim lip extends into said backing plate recess.

3. A method as defined in claim 1, comprising the following steps before the step of applying said shim abutment surface against said backing plate shim surface:
forming at least one hole through said shim; and
forming said lip on said shim about said hole;
wherein the step of applying said shim abutment surface against said backing plate shim surface is accomplished so that said shim hole registers with said backing plate recess and so that said shim lip extends into said backing plate recess.

4. A method as defined in claim 1, further comprising the following step before said shim abutment surface is applied against said backing plate shim surface:
forming an annular shoulder on said backing plate at said inner peripheral wall rim that projects within said recess, wherein upon said shim lip being deformed against said recess inner peripheral wall, said shim lip will partly engage an area underneath said annular shoulder within said recess to be axially retained by said annular shoulder.

5. A method as defined in claim 4, wherein said annular shoulder is formed in said recess by said backing plate formed with said recess being subjected to an abrasive grit blasting operation.

6. A method as defined in claim 3, wherein said hole is formed on said shim by a punching operation accomplished before said shim abutment surface is applied against said backing plate shim surface, said lip being formed concurrently with said hole due to the material of said shim plastically deforming during said punching operation and bending outwardly transversely of said shim abutment surface.

7. A method as defined in claim 2, wherein said shim lip is forced to deform against said recess inner peripheral wall by means of a coining punch that is driven into said hole and said recess when said lip engages said recess, with the diameter of said coining punch being larger than the diameter of said shim lip.

8. A method as defined in claim 3, wherein said shim lip is forced to deform against said recess inner peripheral wall by means of a coining punch that is driven into said hole and said recess when said lip engages said recess, with the diameter of said punch being larger than the diameter of said shim lip to deform said shim lip against said recess inner peripheral wall in a pressure-fitted fashion.

9. A method as defined in claim 8, wherein said coining punch is power-driven into said hole and said recess against the bias of a biasing member biasing said punch away from said hole and said recess, and said punch is retrieved from said hole and said recess by the action of said biasing member.

10. A method as defined in claim 8, further comprising the following step before said shim abutment surface is applied against said backing plate shim surface:
forming an annular shoulder on said backing plate at said inner peripheral wall rim that projects within said recess, wherein upon said shim lip being deformed against said recess inner peripheral wall, said shim lip will partly engage an area underneath said annular shoulder within said recess to be axially retained by said annular shoulder;
wherein upon said coining punch being driven into said hole and said recess, not only will said shim lip deform against said recess inner peripheral wall, but also said shim lip will force said annular shoulder to elastically yieldingly stretch to allow the insertion of said coining punch in said hole and said recess, with said annular shoulder springing back towards its initial position under its intrinsic resiliency upon said coining punch being retrieved from said hole and said recess, said annular shoulder thus gripping said shim lip.

11. A method as defined in claim 3, wherein there are three recesses formed in said backing plate shim surface and three holes bordered by corresponding lips formed in said shim.

12. A method of manufacturing a brake pad assembly for use in a disc brake assembly, comprising the following steps:
providing a backing plate defining distinct shim and friction pad surfaces, said backing plate destined to carry a friction pad on said friction pad surface and comprising at least one recess on said backing plate shim surface, said recess defining an inner peripheral wall having a top rim;
providing a shim defining an abutment surface;
applying said shim abutment surface against said backing plate shim surface; and
forcing said shim to deform locally into said recess and against said recess inner peripheral wall so that a shim lip projecting transversely away from said shim abutment surface will be forced to deform towards said recess inner peripheral wall to become pressure-fitted within said recess thereby securing said shim to said backing plate.

13. A method as defined in claim 12, wherein in the step of providing said shim, said shim comprises at least one embossment comprising said lip about an embossment hole and an embossment bottom wall integrally formed with said lip within said embossment hole, with the step of applying said shim abutment surface against said backing plate shim surface being accomplished so that said shim embossment registers with said backing plate recess and so that said shim lip extends into said backing plate recess.

14. A method as defined in claim 12, wherein in the step of providing said shim, said shim comprises at least one hole and is provided with said lip about said hole, with the step of applying said shim abutment surface against said backing plate shim surface being accomplished so that said shim hole registers with said backing plate recess and so that said shim lip extends into said backing plate recess.

15. A method as defined in claim 12, wherein said backing plate comprises an annular shoulder at said inner peripheral wall rim projecting within said recess, wherein upon said shim lip being deformed against said recess inner peripheral wall, said shim lip will partly engage an area underneath said annular shoulder within said recess to be axially retained by said annular shoulder.

16. A method as defined in claim 14, wherein said shim lip is made with material of said shim that plastically deformed when said hole was formed and bending outwardly transversely of said shim abutment surface.

17. A method as defined in claim 14, wherein said shim lip is forced to deform against said recess inner wall by means of a punch that is driven into said hole and said recess when said lip engages said recess, with the diameter of said punch being larger than the diameter of said shim lip.

18. A method as defined in claim 17, wherein said punch is power-driven into said hole and said recess against the bias of a biasing member biasing said punch away from said hole and said recess, and said punch is retrieved from said hole and said recess by the action of said biasing member.

19. A method as defined in claim 17, wherein in the step of providing said backing plate, said backing plate comprises an annular shoulder at said inner peripheral wall rim that projects within said recess, wherein upon said shim lip being deformed against said recess inner peripheral wall, said shim lip will partly engage an area underneath said annular shoulder within said recess to be axially retained by said annular shoulder;
and wherein upon said coining punch being driven into said hole and said recess, not only will said shim lip deform against said recess inner peripheral wall, but also said shim lip will force said annular shoulder to elastically yieldingly stretch to allow the insertion of said coining punch in said hole and said recess, with said annular shoulder springing back towards its initial position under its intrinsic resiliency upon said coining punch being retrieved from said hole and said recess, said annular shoulder thus gripping said shim lip.

20. A brake pad assembly for use in a disc brake assembly, comprising:
a backing plate defining distinct shim and friction pad surfaces;
a friction pad fixedly attached to said backing plate on said friction pad surface;
a recess made in said backing plate on said shim surface, said recess defining an inner bottom wall and an inner peripheral wall having a top rim;
a shim defining an abutment surface resting against said backing plate shim surface;
a hole made in said shim and registering with said recess;
a lip integrally carried by said shim and projecting within said recess transversely away from said shim abutment surface about said hole, said lip being formed peripherally about a same axis as said hole and engaging said recess inner peripheral wall in pressure-fitted fashion.

21. A brake pad assembly as defined in claim 20, wherein said backing plate defines an annular shoulder projecting inwardly of said recess at said recess inner peripheral wall top rim, with said lip engaging an area within said recess underneath said shoulder whereby said shim is retained by said shoulder.

22. A brake pad assembly as defined in claim 20, wherein said shim defines an embossment defining said hole, with said shim further defining an embossment bottom wall integrally formed with said lip within said embossment hole.
